(19) United States
(12) Patent Application Publication
(10) Pub. No.: US 2026/0086971 A1
(43) Pub. Date: Mar. 26, 2026

(54) PCIe LANE ADAPTER FOR ENABLING FLEXIBLE SWITCHING OF SPEED AND CAPACITY CONFIGURATIONS OF STORAGE DRIVES

(71) Applicant: Sandisk Technologies, Inc., Milpitas, CA (US)

(72) Inventors: KANNIMOLLI SUPRAMANIAM, Bayan Lepas (MY); VIGNES KUMARAN, Batu Kawan (MY); VILAASHINI NAGENDERAN, Simpang Ampat (MY)

(73) Assignee: Sandisk Technologies, Inc., Milpitas, CA (US)

(21) Appl. No.: 18/894,152

(22) Filed: Sep. 24, 2024

(51) Int. Cl. G06F 13/42; G06F 13/40

(52) U.S. Cl. CPC G06F 13/4221; G06F 13/409

(57) ABSTRACT

An interface is provided to adjust a storage setup based on speed and/or capacity. The interface includes a controller that manages downstream peripheral component interconnect express (PCIe) lane configurations. A splitter may split a PCIe lane into multiple configurations based on a configuration of the controller. An adapter includes a set of slots for inserting storage devices to convert the first PCIe lane configuration to the second PCIe lane configuration. The slots on the adapter may split a one storage device to four PCIe lanes (1×4) connector to two separate connectors, each operating at a speed of two storage devices to two PCIe lanes. The slots on the adapter may also split the one storage device to four PCIe lanes (1×4) connector to four separate connectors, each operating at a speed of four storage devices to one PCIe lane.

### BACKGROUND OF THE INVENTION

A storage device may be communicatively coupled to a host and to non-volatile memory including, for example, a NAND flash memory device on which the storage device may store data received from the host. The storage device may be connected to the host via a Peripheral Component Interconnect Express (PCIe) configuration for high-speed data transfer between the host and storage device. Current storage devices may be high-speed storage devices or high-capacity storage devices, wherein existing storage devices may offer a choice between speed-oriented solutions or capacity-oriented solutions. Storage devices offering speed-oriented solutions may feature a PCIe configuration of one solid state drive (SSD) to four PCIe lanes to the host (depicted herein as 1×4), enabling faster data transfer rates. Storage devices offering capacity-oriented solutions may be capable of accommodating multiple SSDs per a PCIe lane configuration including, for example, four SSDs to one PCIe lane (depicted herein as 4×1), thus, prioritizing storage space over speed.

Industry limitations may prevent a single storage device from effectively accommodating both high-speed performance and ample storage capacity, ultimately restricting user flexibility. As such, a user may select a storage device for either speed or capacity, depending on the user's immediate requirements, which may limit overall productivity and flexibility. Current approaches to addressing the speed versus capacity on storage devices primarily focus on PCIe gold finger splitting which may use gold-plated connectors on the edge of printed circuit boards (PCBs), wherein the connectors connect the PCB to other components or systems, such as motherboards, expansion cards, etc. PCIe gold finger splitting is suitable for desktop and server applications and may allow for the splitting of the PCIe lanes from a single PCIe connector, enabling the connection of multiple storage devices. However, PCIe gold finger splitting may not address the splitting of PCIe U.2 lanes, i.e., a hardware interface that connects SSDs to a computer over the PCIe bus and which may be used for storage array or external storage devices. Storage devices using PCIe U.2 lanes may be referred to herein as U.2 storage devices. To increase the number of SSDs and lanes for storage arrays, an approach may implement switch/redundant array of independent disks (RAID) chips. However, this approach comes at a high cost due to the complexity of the chipset, hardware, and firmware involved. There is currently no approach that focuses on splitting the PCIe U.2 lanes and as such, storage arrays and devices lacked an approach to efficiently distribute and utilize PCIe lanes for U.2 SSDs. This may hinder the development of storage arrays and external storage devices that may leverage the benefits of multiple PCIe U.2 lanes. As a result, the speed and capacity of storage systems may not be fully optimized.

### SUMMARY OF THE INVENTION

In some implementations, an interface is provided to adjust a storage setup based on speed and/or capacity. The interface includes a controller that manages downstream peripheral component interconnect express (PCIe) lane configurations.

A splitter may split a PCIe lane into multiple configurations based on a configuration of the controller. The interface also includes an adapter to convert a first PCIe lane configuration to a second PCIe lane configuration to adjust the storage setup based on speed and/or capacity.

The adapter may include a set of slots for inserting storage devices to convert the first PCIe lane configuration to the second PCIe lane configuration. The adapter may also include an upstream connection to a PCIe male connector and downstream connections to PCIe female connectors.

The slots on the adapter may split a one storage device to four PCIe lanes (1×4) connector to two separate connectors, each operating at a speed of two storage devices to two PCIe lanes. The slots on the adapter may also split the one storage device to four PCIe lanes (1×4) connector to four separate connectors, each operating at a speed of four storage devices to one PCIe lane.

### BRIEF DESCRIPTION OF THE DRAWINGS

FIG. 1 is a schematic block diagram of an example system in accordance with some implementations.

FIG. 2 is a schematic diagram of a conversion of a PCIe U.2 1×4 configuration to a PCIe U.2 2×2 configuration in accordance with some embodiments.

FIGS. 3A and 3B are examples of an adapter configuration used in accordance with some embodiments.

FIG. 4 is a schematic diagram of a conversion of a PCIe U.2 1×4 configuration to a PCIe U.2 4×1 configuration in accordance with some embodiments.

FIGS. 5A and 5B are examples of an adapter configuration used in accordance with some embodiments.

FIG. 6 is a diagram of an example environment in which systems and/or methods described herein are implemented.

FIG. 7 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

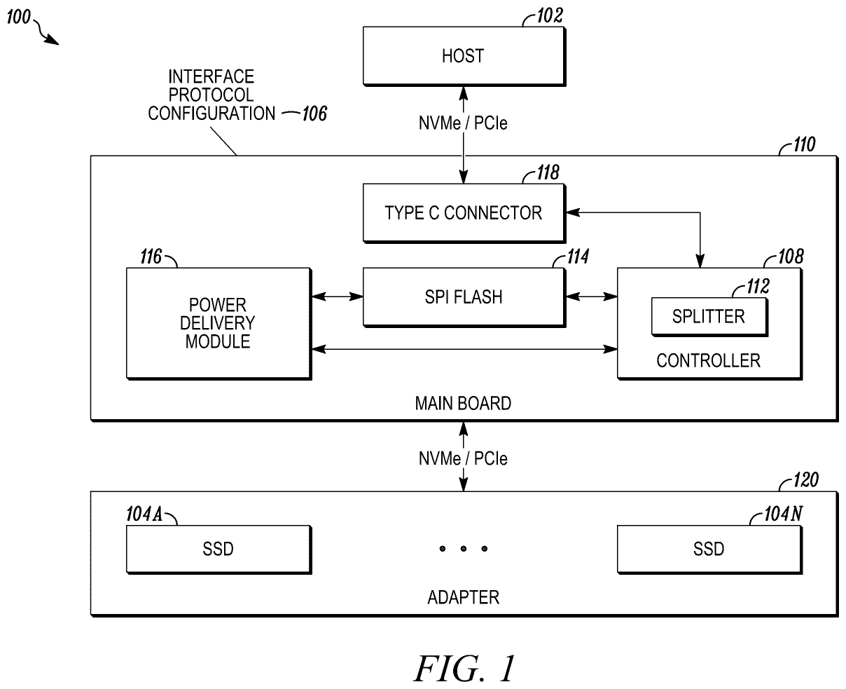

FIG. 1 is a schematic block diagram of an example system in accordance with some implementations. System 100 includes a host 102 and one or more storage devices 104a-104n (generally referred to herein as storage device 104) that may be in the same physical location as components on a single computing device or on different computing devices that are communicatively coupled. Storage device 104 may communicate with host 102 via a Non-Volatile Memory Express (NVMe) protocol over a peripheral component interconnect express (PCIe) interface, and the like. Host 102 may include additional components (not shown in this figure for the sake of simplicity). Storage device 104 may be a U.2 storage device and the interface between host 102 and storage device 104 may support an interface protocol configuration 106 that may be based on a combination of PCIe and DisplayPort. It should be noted that storage device 104 may be other types of storage devices and that the U.2 storage device is described herein as an example.

Interface protocol configuration 106 may include a controller 108 that may have a capability to manage up to four PCIe lane configurations downstream.

Controller 108 may have the capacity to bifurcate up to four storage devices 104 with the PCIe configuration, allowing for diverse configurations including, for example, three SSDs to one PCIe lane (depicted herein as 3×1), two SSDs to one PCIe lane plus one SSD to two PCIe lanes (depicted herein as 2×1+1×2), two SSDs to two PCIe lanes (depicted herein as 2×2), and one SSD to four PCIe lanes (depicted herein as 1×4).

Interface protocol configuration 106 may also include a PCIe U.2 interface downstream and a main board 110 incorporating a splitter 112, wherein by configuring controller 108 to use a 1×4 PCIe configuration, splitter 112 may effectively split the PCIe lanes as necessary for optimal performance. Through the use of a programming interface, a Serial Peripheral Interface (SPI) flash memory 114 may be programmed or overwritten to configure the PCIe lanes according to a desired setup. This flexibility in lane configuration may ensure compatibility with various storage devices while maximizing the efficiency and functionality of system 100. Interface protocol configuration 106 may also include a power delivery module 116 for delivering power to controller 108 and a type C connector 118 for connecting with host 102.

An adapter 120 may leverage controller 108 capabilities to enable seamless PCIe lane configurations and enhance the overall performance and versatility in data transfer and storage applications. Adapter 120 may be used to convert a first PCIe U.2 lane configuration to a second PCIe U.2 lane configuration. In one configuration, adapter 120 may be designed to convert the first PCIe U.2 lane configuration (for example, a PCIe U.2 1×4 configuration) to a two PCIe U.2 2×2 configuration. In this configuration, adapter 120 may split the PCIe U.2 lanes from a single PCIe U.2 lane connector into two separate PCIe U.2 lane connectors, each operating at a speed of 2×2. Adapter 120 may connect a PCIe U.2 male connector as an upstream connection and the downstream connections on adapter 120 may be PCIe U.2 female connectors.

In another configuration, adapter 120 may be designed to convert the first PCIe U.2 lane configuration (for example, a PCIe U.2 1×4 configuration) to a four PCIe U.2 4×1 configuration. Adapter 120 may split the PCIe U.2 lanes from a single PCIe U.2 lane connector into four separate PCIe U.2 lane connectors, each operating at a speed of 4×1 configuration. Adapter 120 may use a PCIe U.2 male connector as the upstream connection and the downstream connections on may be PCIe U.2 female connectors. Adapter 120 may thus allow for the expansion of PCIe U.2 lanes by dividing a PCIe U.2 lane into multiple lanes. This may be useful in scenarios where multiple PCIe U.2 SSDs need to be connected to a single PCIe U.2 port, such as in high-performance storage systems.

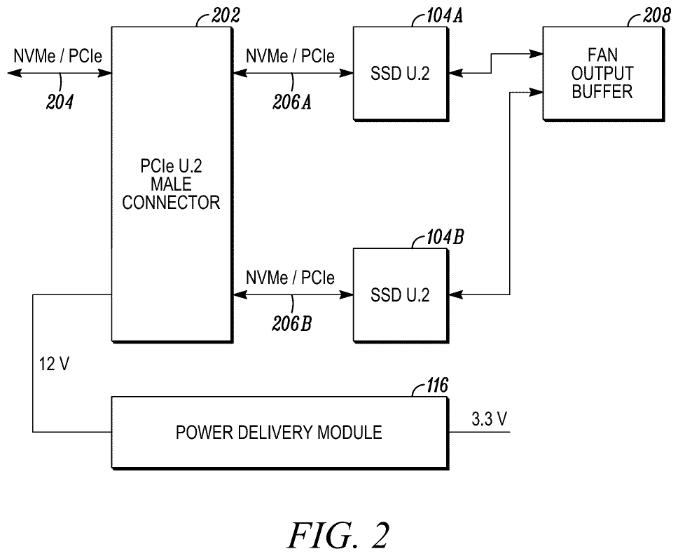

FIG. 2 is a schematic diagram of a conversion of a PCIe U.2 1×4 configuration to a PCIe U.2 2×2 configuration in accordance with some embodiments. Adapter 120 may connect a PCIe U.2 male connector 202 as an upstream connection. Adapter 120 may split a single PCIe U.2 lane 204 into two separate PCIe U.2 lanes 206A and 206B to convert a PCIe U.2 1×4 configuration to a PCIe U.2 2×2 configuration, each with a 2×2 configuration. The downstream connections on this adapter may be PCIe U.2 female connectors. SSD U.2 104a and SSD U.2 104b in the PCIe U.2 2×2 configuration may be connected to a PCIe fan output buffer 208. Power delivery controller 116 may supply power to connector 202. As indicated above FIG. 2 is provided as an example. Other examples may differ from what is described in FIG. 2.

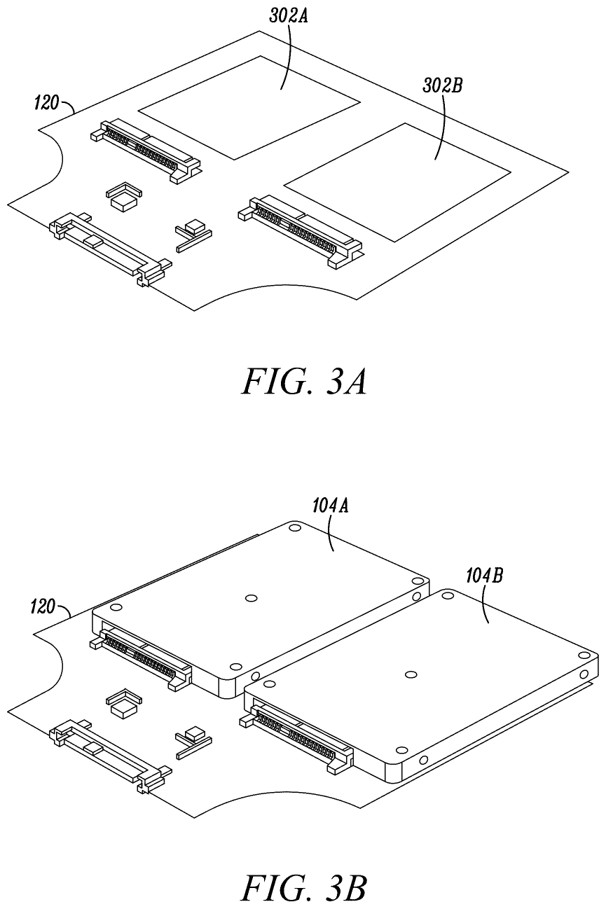

FIGS. 3A and 3B are examples of an adapter configuration used in accordance with some embodiments. Adapter 120 may be used to split the PCIe lanes from a single PCIe U.2 (1×4) connector into two separate PCIe U.2 connectors, each operating at a speed of 2×2. Adapter 120 may enable users to distribute the PCIe lanes across two PCIe U.2 storage devices, striking a balance between speed and capacity. In FIG. 3A, adapter 120 is shown with two slots 302a and 302b for connecting two storage devices 104. Adapter 120 may leverage the capabilities of controller 108 to enable seamless PCIe lane configurations and enhance overall performance and versatility in data transfer and storage applications. In FIG. 3B, slots 302a and 302b are used to house storage devices 104a and 104b that may be configured in a PCIe U.2 2×2 configuration. As indicated above FIGS. 3A and 3B are provided as examples. Other examples may differ from what is described in FIGS. 3A and 3B.

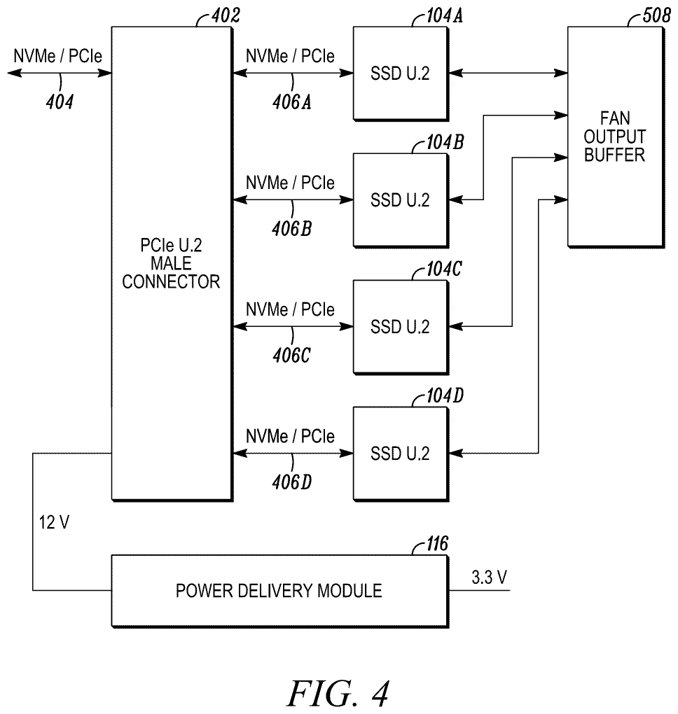

FIG. 4 is a schematic diagram of a conversion of a PCIe U.2 1×4 configuration to a PCIe U.2 4.1 configuration in accordance with some embodiments. Adapter 120 may include a PCIe U.2 male connector 402 as an upstream connection. Adapter 120 may split a single PCIe U.2 lane 404 into four separate PCIe U.2 lanes 406a-406d configuration to convert the PCIe U.2 1×4 configuration to a PCIe U.2 4×1 configuration. The downstream connections on this adapter configuration may be PCIe U.2 female connectors. SSD U.2 104a, SSD U.2 104b, SSD U.2 104c, and SSD U.2 104d in the PCIe U.2 4×1 configuration may be connected to a PCIe fan output buffer 508. Power delivery controller 116 may supply power to controller 108. As indicated above FIG. 4 is provided as an example. Other examples may differ from what is described in FIG. 4.

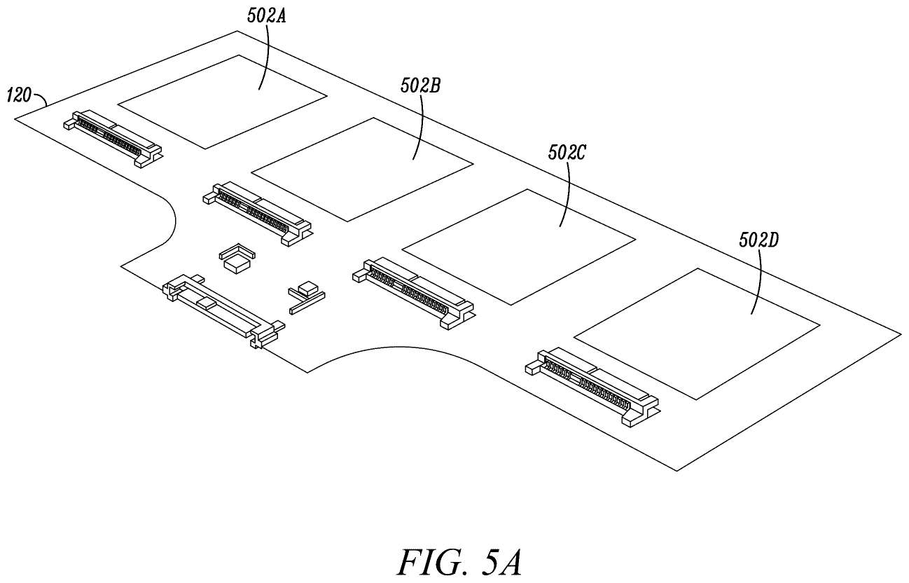

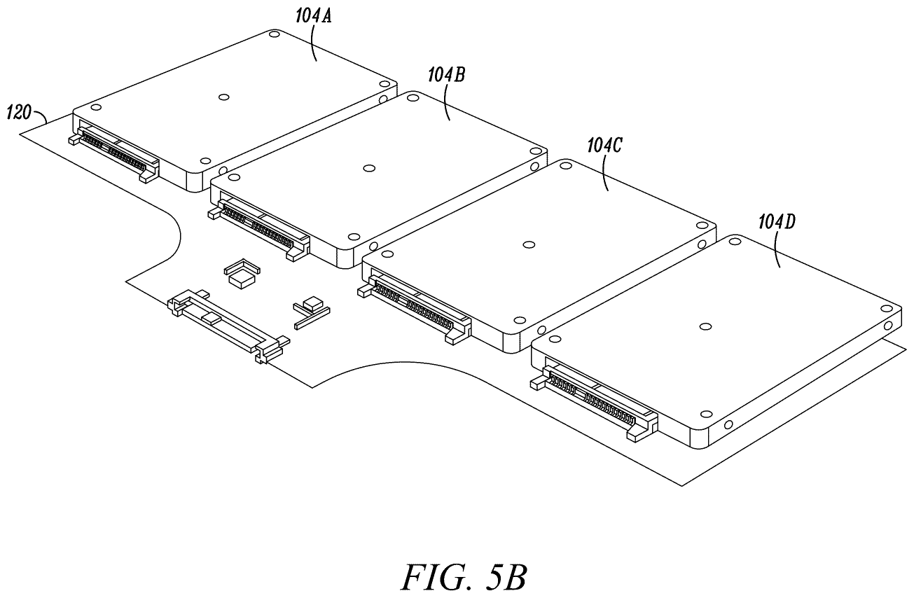

FIGS. 5A and 5B are examples of an adapter configuration used in accordance with some embodiments. Adapter 120 may allow for the division of PCIe lanes from a single PCIe U.2 (×4) connector into four individual PCIe U.2 connectors, each operating at a speed of 4×1. Adapter 120 may enable users to utilize the PCIe lanes across four PCIe U.2 storage devices 104, further enhancing both capacity and potential storage performance. In FIG. 5A, adapter 120 is shown with four slots 502a-502d for connecting four storage devices 104. Adapter 120 may leverage the capabilities of controller 108 to enable seamless PCIe lane configurations. In FIG. 5B, slots 502a-502d may be used to house storage devices 104a-104d, each of which may be configured in a PCIe U.2 4×1 configuration. As indicated above FIG. 5 is provided as an example. Other examples may differ from what is described in FIG. 5.

Adaptor 120 may provide increased flexibility and performance options by allowing the splitting of PCIe lanes among multiple PCIe U.2 storage devices 104. With the ability to switch between different adapter configurations, storage setup may be adjusted based on a requirement for higher speed, increased capacity, or a combination of both.

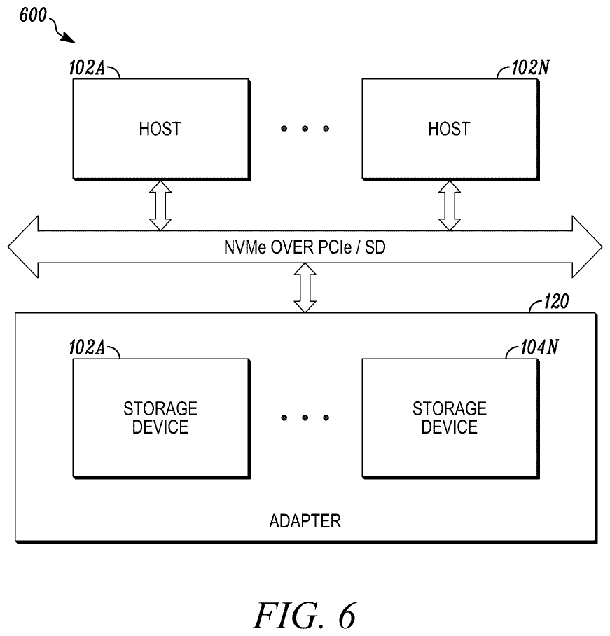

FIG. 6 is a diagram of an example environment in which systems and/or methods described herein are implemented. As shown in FIG. 6, Environment 600 may include hosts 102-102n (referred to herein as host(s) 102), and one or more storage devices 104a-104n (referred to herein as storage device(s) 104). Environment 500 may include adapters 120 to split PCIe lanes into various configurations to adjust the storage setup for speed and/or capacity. Hosts 102 and storage devices 104 may communicate via Non-Volatile Memory Express NVMe over PCIe, or the like.

Devices of Environment 600 may interconnect via wired connections, wireless connections, or a combination of wired and wireless connections. For example, the network in FIG. 6 may include NVMe over Fabric(NVMe-oF) Internet Small Computer Systems Interface(iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of Environment 600 may perform one or more functions described as being performed by another set of devices of Environment 600.

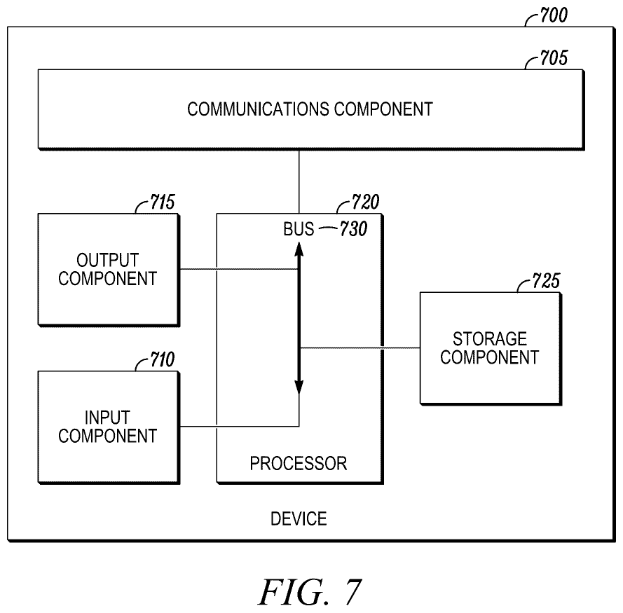

FIG. 7 is a diagram of example components of one or more devices of FIG. 1. In some implementations, host 102 may include one or more devices 700 and/or one or more components of device 700. Device 700 may include, for example, a communications component 705, an input component 710, an output component 715, a processor 720, a storage component 725, and a bus 730. Bus 730 may include components that enable communication among multiple components of device 700, wherein components of device 700 may be coupled to be in communication with other components of device 700 via bus 730.

Input component 710 may include components that permit device 700 to receive information via user input (e.g., keypad, a keyboard, a mouse, a pointing device, and a network/data connection port, or the like), and/or components that permit device 700 to determine the location or other sensor information (e.g., an accelerometer, a gyroscope, an actuator, another type of positional or environmental sensor). Output component 715 may include components that provide output information from device 700 (e.g., a speaker, display screen, and network/data connection port, or the like). Input component 710 and output component 715 may also be coupled to be in communication with processor 720.

Processor 720 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 720 may include one or more processors capable of being programmed to perform a function. Processor 720 may be implemented in hardware, firmware, and/or a combination of hardware and software.

Storage component 725 may include one or more memory devices, such as random-access memory (RAM), read-only memory (ROM), and/or another type of dynamic or static storage device (e.g., a flash memory, a magnetic memory, and/or optical memory) that stores information and/or instructions for use by processor 720. A memory device may include memory space within a single physical storage device or memory space spread across multiple physical storage devices. Storage component 725 may also store information and/or software related to the operation and use of device 700. For example, storage component 725 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 705 may include a transceiver-like component that enables device 700 to communicate with other devices, such as via a wired connection, a wireless connection, or a combination of wired and wireless connections. The communications component 705 may permit device 700 to receive information from another device and/or provide information to another device. For example, communications component 705 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 705 may also include one or more broadband and/or narrowband transceivers and/or other similar types of wireless transceiver configurable to communicate via a wireless network for infrastructure communications. Communications component 705 may also include one or more local area network or personal area network transceivers, such as a Wi-Fi transceiver or a Bluetooth transceiver.

Device 700 may perform one or more processes described herein. For example, device 700 may perform these processes based on processor 720 executing software instructions stored by a non-transitory computer-readable medium, such as storage component 725. As used herein, the term “computer-readable medium” refers to a non-transitory memory device. Software instructions may be read into storage component 725 from another computer-readable medium or from another device via communications component 705. When executed, software instructions stored in storage component 725 may cause processor 720 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more. ” Furthermore, as used herein, the term “set” is intended to include one or more items (e.g., related items, unrelated items, a combination of related items, unrelated items, and/or the like), and may be used interchangeably with “one or more. ” The term “only one” or similar language is used where only one item is intended. Further, the phrase “based on” is intended to mean “based, at least in part, on”unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. An interface to adjust a storage setup based on at least one of speed and capacity, the interface comprises:
a controller to manage downstream peripheral component interconnect express (PCIe) lane configurations;
a splitter to split a PCIe lane into multiple configurations based on a configuration of the controller; and
an adapter to convert a first PCIe lane configuration to a second PCIe lane configuration to adjust the storage setup based on at least one of speed and capacity.

2. The interface of claim 1, wherein the first PCIe lane configuration is a configuration of one storage device to four PCIe U.2 lanes (1×4) and the adapter converts the first PCIe lane configuration to the second PCIe lane configuration.

3. The interface of claim 2, wherein the second PCIe lane configuration includes two separate PCIe lanes, each with a configuration of two storage devices to two PCIe lanes.

4. The interface of claim 2, wherein the second PCIe lane configuration includes four separate PCIe U.2 lanes, each with a configuration of four storage devices to one PCIe U.2 lane (4×1).

5. The interface of claim 1, wherein the adapter connects to a PCIe male connector as an upstream connection.

6. The interface of claim 1, wherein downstream connections on the adapter are PCIe female connectors.

7. The interface of claim 1, further comprising a memory programmed to configure the PCIe lane according to a desired setup.

8. The interface of claim 1, further comprising a power delivery controller to deliver power to the controller.

9. The interface of claim 1, further comprising a type C connector to connect the interface to a host.

10. The interface of claim 1, wherein the controller manages up to four PCIe lane configurations downstream.

11. An adapter to adjust a storage setup based on at least one of speed and capacity, the adapter comprises:
a set of slots to insert storage devices and convert a first PCIe lane configuration to a second PCIe lane configuration;
an upstream connection to a PCIe male connector; and
downstream connections to PCIe female connectors.

12. The adapter of claim 11, wherein the first PCIe lane configuration is a one storage device to four PCIe U.2 lanes (1×4) configuration and the adapter converts the first PCIe lane configuration to the second PCIe lane configuration including two separate PCIe lanes, each with a configuration of two storage devices to two PCIe lanes.

13. The adapter of claim 11, wherein the first PCIe lane configuration is a one storage device to four PCIe U.2 lanes (1×4) configuration and the adapter converts the first PCIe lane configuration to the second PCIe lane configuration including four separate PCIe U.2 lanes, each with a configuration of four storage devices to one PCIe U.2 lane (4×1).

14. The adapter of claim 11, wherein the adapter connects to a PCIe male connector as an upstream connection.

15. The adapter of claim 11, wherein downstream connections on the adapter are PCIe female connectors.

16. The adapter of claim 11, wherein the first PCIe lane configuration is provided by a controller configured to provide a one storage device to four PCIe U.2 lanes (1×4) configuration.

17. An adapter to adjust a storage setup based on at least one of speed and capacity, the adapter comprises:
a set of slots for inserting storage devices to split a one storage device to four PCIe lanes (1×4) connector to one of two separate connectors, each operating at a speed of two storage devices to two PCIe lanes, and four separate connectors, each operating at a speed of four storage devices to one PCIe lane;
an upstream connection to a PCIe male connector; and
downstream connections to PCIe female connectors.

18. The adapter of claim 17, wherein the adapter connects to a PCIe male connector as an upstream connection.

19. The adapter of claim 17, wherein downstream connections on the adapter are PCIe female connectors.

20. The adapter of claim 17, wherein a first PCIe lane configuration including a one storage device to four PCIe U.2 lanes (1×4) configuration is provided by a controller and is used for the one storage device to four PCIe lanes (1×4) connector.
